(19) United States
(12) Patent Application Publication
(10) Pub. No.: US 2022/0345202 A1
(43) Pub. Date: Oct. 27, 2022

(54) METHODS AND RADIO ACCESS NETWORK NODES OF AN INTEGRATED ACCESS AND BACKHAUL COMMUNICATION NETWORK

(71) Applicant: Telefonaktiebolaget LM Ericsson (publ), Stockholm (SE)

(72) Inventors: Yezi HUANG, Täby (SE); Boris DORTSCHY, Hägersten (SE); Eduardo LINS DE MEDEIROS, Sundbyberg (SE); Behrooz MAKKI, Göteborg (SE)

(21) Appl. No.: 17/615,763

(22) PCT Filed: Jun. 20, 2019
(86) PCT No.: PCT/SE2019/050593

§ 371 Date: Dec. 1, 2021

(51) Int. Cl. H04B 7/155; H04L 1/18

(52) U.S. Cl. CPC H04B 7/15542; H04L 1/1822; H04L 1/189

(57) ABSTRACT

A method performed by a first RAN node of an integrated access and backhaul, IAB, wireless communication network. The first RAN node is connected to a core network and is arranged for wireless communication with a second RAN node and with a number of UEs. Wireless communication resources are allocated for communication between the first RAN node and the second RAN node. The method includes assigning a first part of the resources for transmission of first data and a second part for transmission of second data between the first RAN node and the second RAN node, obtaining information of a vacant part of the resources, and triggering transmission of the first data and the second data using at least a fraction of the vacant part of the wireless communication resources for at least one of the first data and the second data.

### TECHNICAL FIELD

The present disclosure relates generally to methods and radio access network nodes of an integrated access and backhaul (IAB) wireless communication network. The present disclosure further relates to computer programs and carriers corresponding to the above methods and nodes.

### BACKGROUND

In wireless communication networks, densification via the deployment of base stations, aka radio access network (RAN) nodes, is one of the mechanisms that can be employed to satisfy the ever-increasing demand for more and more bandwidth and capacity. Due to the availability of more spectrum in the millimeter wave band, deploying small cells that operate in this band is an attractive option for these purposes. However, deploying fiber to the small cells, which is the usual way in which small cells are deployed, can end up being very expensive and impractical. Thus, employing a wireless link for connecting the small cells to the operator's network, i.e. core network, is a more cost-efficient and practical alternative. One such solution is an integrated access and backhaul (IAB) communication network, where the operator can utilize part of the radio resources for the backhaul link, i.e. for communication between the core network and some of the RAN nodes.

In an IAB network, radio access communication and backhaul communication share wireless communication resources. Radio access communication is communication between a RAN node and User Equipments (UEs). In non-IAB networks, backhaul communication is only communication between a RAN node and the core network. In IAB networks, backhaul communication is, except for being between the RAN node and the core network also between RAN nodes. The radio access communication and the backhaul communication may share wireless communication resources by the communication taking place in overlapping and/or non-overlapping spectrum. What is new here compared to regular wireless communication networks is that the backhaul communication is at least partly performed wirelessly and over wireless communication resources shared with the radio access communication between RAN node and UE. The IAB network could for example be applicable in a gNB or in a distributed base station, e.g. to send between distributed units (DUs) in New Radio (NR)-based networks, where the DUs handles radio link control (RLC) layer and lower, over the shared wireless communication resources.

FIG. 1 shows an exemplary IAB network 100 comprising an IAB donor node 130, a first IAB node 110 and a second IAB node 120. The IAB nodes 110, 120, 130 are RAN nodes. The IAB donor node 130 has a wireline connection to a core network 150 and the first and second IAB nodes 110, 120 are wirelessly connected to the IAB donor node 130, the first IAB node 110 directly and the second IAB node 120 indirectly via the first IAB node 110. The connections 117, 127 and 137 between any of the IAB nodes 110, 120, 130 and their respective UEs 111, 112, 121, 122, 131 and 132 are called access links, whereas the connection 115 between the first IAB node 110 and the second IAB node 120 and the connection 135 between the IAB donor node 130 and the first IAB node 110 are called backhaul links.

Furthermore, an adjacent upstream node of an IAB node, i.e. a node which is closer to the core network than the IAB node, is referred to as a parent node of the IAB node. As in the example of FIG. 1, the first IAB node 110 is a parent node to the second IAB node 120. Further, an adjacent downstream node of an IAB node, i.e. a node which is further away from the core network than the IAB node, is referred to as a child node of the IAB node. E.g. the second IAB node 120 of FIG. 1 is a child node to the first IAB node 110. The backhaul link between a parent node and the IAB node is referred to as parent (backhaul) link, whereas the backhaul link between the IAB node and the child node is referred to as child (backhaul) link. As in the example of FIG. 1, the backhaul link 135 between the IAB donor node 130 and the first IAB node 110 is the parent link of the first IAB node 110, whereas the backhaul link 115 between the first IAB node 110 and the second IAB node 120 is the child link of the first IAB node 110.

It is not uncommon that a wireless transmission between a UE and a RAN node is utilizing some measures of protection to, e.g., improve the level of reliability or improved efficiency. FIG. 2 illustrates the transmission process in DL in LTE or NR that incorporates an Automatic Repeat Request (ARQ) procedure in the RLC layer and/or a Hybrid ARQ (HARQ) in the MAC layer of a RAN node 230. After processing received 242 BH user data by higher network layers including PDCP, RLC and MAC, the user data is transmitted 244 over a wireless connection to a UE 220. The UE 220 receives the data and, after decoding, checks whether the data is error free using CRC information. If the data is found error free by the UE 220, the UE sends 246 back to the RAN node 230 an acknowledgement (ACK). If the data is not found error free by the UE or remains undetected, it sends 246 back to the RAN a non-acknowledgement (NACK) message is sent. If the RAN node 230 receives an ACK, it transmits 250 new user data. In case of a missing ACK or if the UE sent a NACK to the RAN, the RAN HARQ process re-transmits 248, or at least partially re-transmits, the existing user data, possibly with a different revision.

In a multi-hop IAB network, such as in the example of FIG. 1, IAB nodes connected to the core network via an IAB donor node can experience reduced backhaul throughput, the further away from the IAB donor node in terms of wireless hops, the more reduced may the received backhaul data be. This can occur due to a large number of access UEs camping in intermediate IAB nodes, for example, that share traffic over links with limited BH capacity closer to the IAB donor node. At the same time, and especially due to necessary retransmission between IAB nodes, e.g. performed according to the ARQ/HARQ process described above, the delay experienced by access UEs served by IAB nodes further away from the IAB donor node is increasing. The reduced BH traffic, relative to available BH resources, at some IAB nodes leads to redundant backhaul resources. As described, there is an interest in reducing the delay at UEs in an IAB communication network and/or improving data transmission reliability. Further, there is an interest in a better usage of backhaul communication resources in an IAB communication network.

### SUMMARY

It is an object of the invention to address at least some of the problems and issues outlined above. It is possible to achieve these objects and others by using methods and RAN nodes as defined in the attached independent claims.

According to one aspect, a method is provided performed by a first RAN node of an IAB wireless communication network, the IAB wireless communication network further comprising a second RAN node. The first RAN node is connected to a core network. Further, the first RAN node is arranged for wireless communication with the second RAN node and with a number of UEs. Further, wireless communication resources are allocated for communication between the first RAN node and the second RAN node, The method comprises assigning a first part of the wireless communication resources for transmission of first data between the first RAN node and the second RAN node at a time period, the first data being related to a first UE connected to the second RAN node, and assigning a second part of the wireless communication resources for transmission of second data between the first RAN node and the second RAN node at the time period. The method further comprises obtaining information of a vacant part of the wireless communication resources at the time period, and triggering transmission of the first data and the second data between the first RAN node and the second RAN node at the time period using the first part of the wireless communication resources for the first data, the second part of the wireless communication resources for the second data and at least a fraction of the vacant part of the wireless communication resources for at least one of the first data and the second data.

According to another aspect, a first RAN node is provided operable in an IAB wireless communication network. The first RAN node is arranged for being connected to a core network and for wireless communication with a second RAN node and with a number of UEs. The first RAN node is further allocated wireless communication resources for communication with the second RAN node. The first RAN node comprises a processing circuitry and a memory. Said memory contains instructions executable by said processing circuitry, whereby the first RAN node is operative for assigning a first part of the wireless communication resources for transmission of first data between the first RAN node and the second RAN node at a time period, the first data being related to a first UE connected to the second RAN node, and for assigning a second part of the wireless communication resources for transmission of second data between the first RAN node and the second RAN node at the time period. The first RAN node is further operative for obtaining information of a vacant part of the wireless communication resources at the time period, and for triggering transmission of the first data and the second data between the first RAN node and the second RAN node at the time period using the first part of the wireless communication resources for the first data, the second part of the wireless communication resources for the second data and at least a fraction of the vacant part of the wireless communication resources for at least one of the first data and the second data.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram illustrating an example of an IAB network.

FIG. 2 is a signaling diagram illustrating a HARQ process according to prior art.

FIG. 3 is a schematic block diagram illustrating a communication scenario in an example of an IAB network.

FIG. 4 is a schematic block diagram illustrating another example of an IAB network.

FIG. 5 is a flow chart illustrating a method performed by a first RAN node of an IAB network, according to possible embodiments.

FIG. 6 is a flow chart of embodiments of another method performed by a first RAN node of an IAB network.

FIG. 7 is a flow chart of other embodiments of another method performed by a first RAN node of an IAB network.

FIG. 8 is a block diagram of an example of data unit duplication according to possible embodiments.

FIG. 9 is a block diagram illustrating a first RAN node of an IAB network in more detail, according to further possible embodiments.

### DETAILED DESCRIPTION

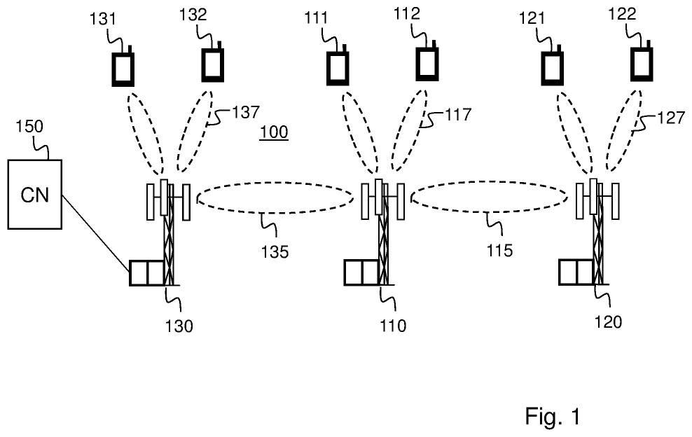

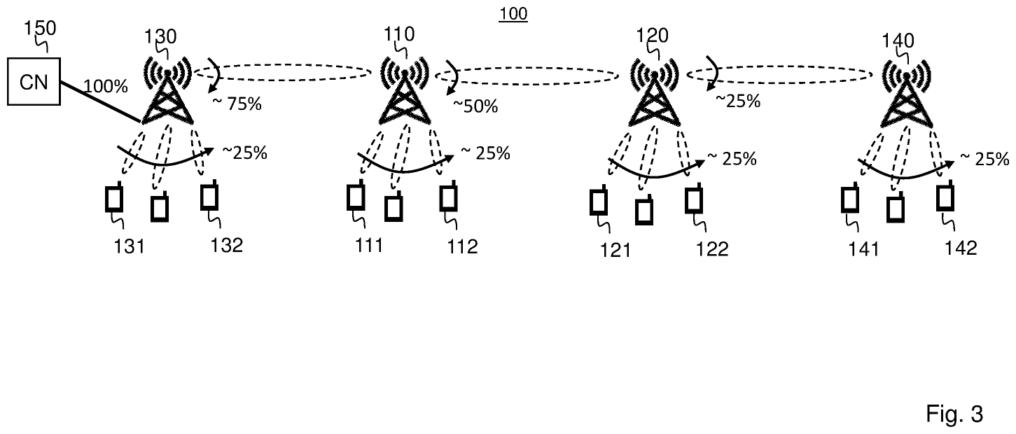

In some IAB network configurations, the transmission capacity that a RAN node can provide to served UEs is not fully utilized. A reason for that can be that the RAN node's backhaul (BH) link traffic load is lower than the RAN node's total wireless transmission capacity. FIG. 3 illustrates such a case. The exemplary architecture of FIG. 3 is similar to the FIG. 1 architecture except that a third IAB node 140 has been added as a child node to the second IAB node 120. The third IAB node 140 has in its turn UEs 141, 142 connected to it via its access links. In IAB networks, the IAB donor node's 130 BH link carries the aggregated uplink (UL) and downlink (DL) traffic of all IAB nodes connected through the IAB donor node 130 to the core network 150, here the first, second and third IAB node 110, 120, 140. DL in an IAB network means from the IAB donor node towards child IAB nodes and UL means IAB child nodes towards the IAB donor node. In this example, it is assumed for the sake of simplicity that all BH links have similar properties, such as BH link capacity, and that all access links have similar properties, such as access link capacity, and that the IAB donor node 130 and the IAB nodes 110, 120, 140 serve an about equal number of UEs. Then, the BH link resource utilization (time- and or frequency-resources) will decrease further away from the IAB donor node 130. For the topology as depicted in FIG. 3, an equal number of served UEs per IAB node or IAB donor node results in about 25% of the donor wireline BH traffic, which is assumed to be 100%, is provided to access UEs by each node. The BH traffic carried over the wireless BH links is about 75% between the IAB donor node 130 and the first IAB node 110 and only 25% between the second IAB node 120 and the third IAB node 140. With the assumption of about equal BH link properties, some BH links carry only a fraction, i.e. a third, of the traffic than other IAB BH links and therefore utilize only a fraction, i.e. a third, of the wireless link resources, if operated under similar assumptions, such as scheduling and resource utilization policies. In other words, in such an example IAB network, there are lots of spare or vacant BH communication resources. According to embodiments, such vacant resources, when occurring, are used for transmitting existing data in a more robust way. As an end result, due to e.g. less re-transmission in the network, data will be delivered faster through an IAB network.

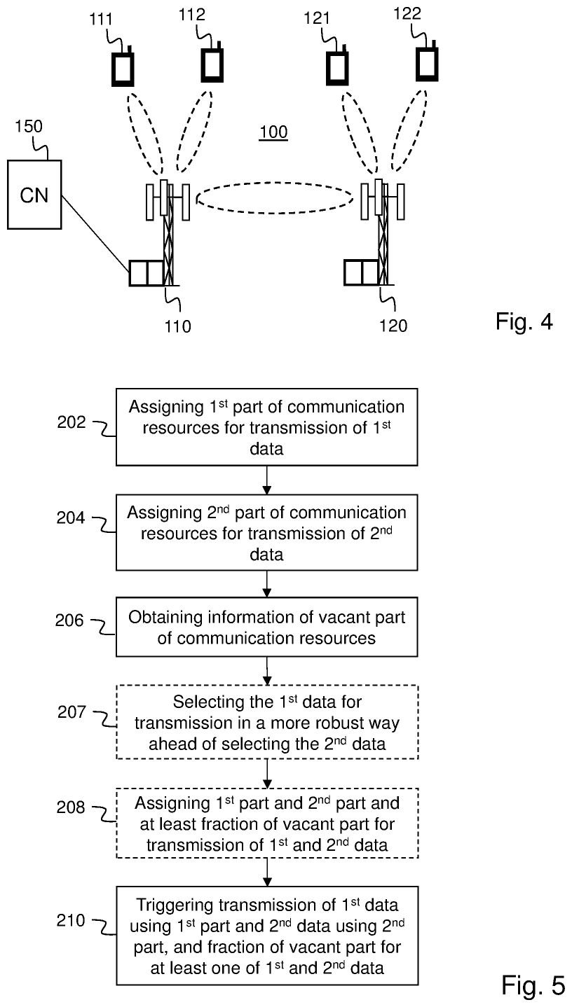

FIG. 4 shows an exemplary IAB network 100, in which as well as in the example of FIG. 1 the present invention may be used. In FIG. 4, in contrast to FIG. 1, the first IAB node 110 is connected via wireline to the core network whereas in FIG. 1 the first IAB node 110 is connected to the core network via a wireless connection to a donor IAB node 130 which it in its turn is connected via wireline to the core network 150. Otherwise, the same reference number applies. The IAB nodes may as well be called RAN nodes.

The IAB network 100 may be implemented in any kind of wireless communication network that can provide radio access to wireless communication devices. Examples of such wireless communication networks are Long Term Evolution (LTE), LTE Advanced, Wireless Local Area Networks (WLAN), Worldwide Interoperability for Microwave Access (WiMAX), WiMAX Advanced, as well as fifth generation wireless communication networks based on technology such as New Radio (NR).

The RAN nodes 110, 120, 130 may be any kind of network nodes that is able to provide wireless access to a wireless communication device alone or in combination with another network node, as well as can communicate wirelessly with other RAN nodes. Examples of RAN nodes 130 are a base station (BS), a radio BS, a base transceiver station, a Node B (NB), an evolved Node B (eNB), a NR BS aka. gNB, a Multi-cell/multicast Coordination Entity, a relay node, an access point (AP), a radio AP, a remote radio unit (RRU), a remote radio head (RRH) and a multi-standard BS (MSR BS).

The UEs 111, 112, 121, 122, 131, 132 may be any type of device capable of wireless communication with a RAN node 110, 120, 130 using radio signals. The UE may also be called wireless communication device. The UE may be a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE) etc.

FIG. 5, in conjunction with FIG. 1, 3 or 4, describes a method performed by a first RAN node 110 of an IAB wireless communication network 100, the IAB wireless communication network further comprising a second RAN node 120. The first RAN node 110 is connected to a core network 150. Further, the first RAN node 110 is arranged for wireless communication with the second RAN node 120 and with a number of UEs 111, 112. Further, wireless communication resources are allocated for communication between the first RAN node 110 and the second RAN node 120, the method comprises assigning 202 a first part of the wireless communication resources for transmission of first data between the first RAN node 110 and the second RAN node 120 at a time period, the first data being related to a first UE 121 connected to the second RAN node, and assigning 204 a second part of the wireless communication resources for transmission of second data between the first RAN node 110 and the second RAN node 120 at the time period. The method further comprises obtaining 206 information of a vacant part of the wireless communication resources at the time period, and triggering 210 transmission of the first data and the second data between the first RAN node 110 and the second RAN node 120 at the time period using the first part of the wireless communication resources for the first data, the second part of the wireless communication resources for the second data and at least a fraction of the vacant part of the wireless communication resources for at least one of the first data and the second data.

The wireless communication resources mentioned above may also be called wireless backhaul communication resources. The first RAN node 110 may be directly connected to the core network or it may be connected to the core network via a wireless connection to another RAN node, such as a donor node. When the first RAN node 110 has obtained 206 information that not all allocated wireless backhaul communication resources between the first and the second RAN node are to be used, the first RAN node triggers transmission of any of the first and second data in a more robust way than planned according to the assigning steps 202, 204. Transmitting in “a more robust way” could be transmitting the first and/or second data using a more robust transport format, e.g. a lower Modulation and Coding Scheme (MCS) than assigned, or by retransmission of at least a part of the first and/or second data within the same time period. As the retransmission here is planned and takes place within the same time period by sending the same information at least twice, it may also be called “duplicate transmission”. Hereby, the wireless backhaul communication resources are better utilized. This is especially true for an IAB network having many consecutive child IAB nodes, so that a third RAN node is wirelessly connected to the first RAN node via a wireless connection to the second RAN node and so on. At the assigning steps, each data to be transmitted is assigned a certain amount of wireless communication resources. When it is observed that in total, all data and control information to be transmitted during a time period directed to UEs of the second RAN node or to subsequent RAN nodes, will not use the total amount of backhaul wireless communication resources, the individual data to be transmitted between the first and second IAB node is transmitted in a more robust way. That a part of the first communication resources are vacant at the time period means that they are not assigned for any transmission of data at the time period. The received information of a vacant part of the wireless communication resources may include information of the size of the vacant part and possibly also availability over time. The vacant part of the wireless communication resources may be due to limited amount of data available to be transmitted over the wireless communication resources. The second data may be related to for example a second UE 122 connected to the second RAN node 120, a third UE connected to a child RAN node which in its turn is connected to the second RAN node or the second data may be control information for the second RAN node 120, or for any child RAN node. Wireless communication resources are divided with respect to frequency and time, into time-frequency resources. In addition, the wireless communication resources may be divided in space. Further, by transmitting the first and second data in a more robust way means that less often the data need to be retransmitted in a later time period. In total this results in a statistically faster and/or more reliable delivery of data to child IAB nodes of an IAB network. Also, there will be less ACK/NACK signaling involved with less retransmissions.

According to an embodiment, the method further comprises assigning 208 the first part of the communication resources for the transmission of the first data, the second part for the transmission of the second data and at least fraction of the vacant part for the transmission of at least one of the first data and the second data. Further, the triggering 210 of transmission is performed according to the assigning 208 of the first part, the second part and the at least fraction of the vacant part. This embodiment ensure that the fraction of the vacant resources are assigned to the transmission of the first and second data, before triggering the transmission.

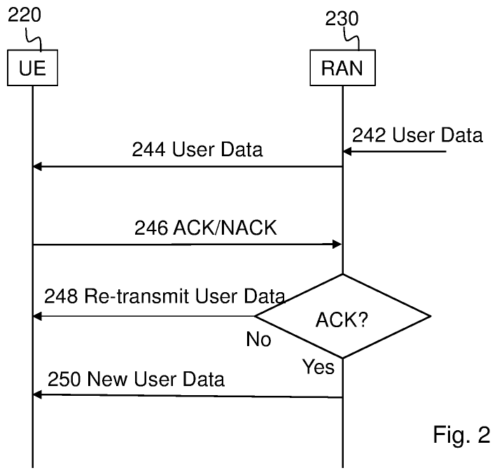

According to another embodiment, the first RAN node 110 is connected to the core network 150 via a wireless connection to a donor RAN node 130, and the donor RAN node 130 is arranged for wireless communication with a number of UEs 131, 132. Here it is defined that the first RAN node 110 may be connected to the core network 150 via a wireless connection to another RAN node called a donor RAN node 130, such as in the example of FIG. 1. In fact, such a wireless connection could be via more than one other RAN node, i.e. the first RAN node could be the second, third, fourth etc. in line from the wireline connection to the core network, see for example FIG. 2. The further away from the core network, the more probable it will be that there are spare wireless communication resources between the first and the second RAN node.

According to another embodiment, the information of a vacant part of the wireless communication resources at the time period comprises information of the amount of vacant resources. The method further comprises, when the amount of vacant resources is above a level, selecting the first data and the second data for transmission in a more robust way. Further, the triggering 210 of transmission of the first data and the second data comprises triggering transmission of the first data using the first part of the wireless communication resources and a first fraction of the vacant part and triggering transmission of the second data using the second part of the wireless communication resources and a second fraction of the vacant part. Hereby, when it is detected that there are enough vacant resources, the vacant resources can be used for transmitting both the first and second data in a more robust way.

According to another embodiment, the triggering 210 of transmission of the first data and the second data comprises triggering transmission of the second data using the second part of the wireless communication resources and at least a fraction of the vacant part by transmitting at least a fraction of the second data in a more robust transport format than a transport format selected at the assigning 204 of the second part of the wireless communication resources. A more robust transport format may e.g. by using a lower MCS compared to the MCS selected at the assigning 202, 204. By using a more robust transport format, the risk of having to retransmit the data in a later time period is lowered. In the end this means a statistically faster delivery of data to/from child IAB nodes.

According to yet another embodiment, the triggering 210 of transmission of the first data and the second data comprises triggering transmission of the second data using the second part of the wireless communication resources and at least a fraction of the vacant part by transmitting at least a fraction of the second data at at least two occasions within the time period. The “two occasions” may be using two different wireless communication resources for sending the fraction of the second data two times, such as at two different time point within the time period or at two different frequencies within the time period. The repetition maybe in encoded or un-encoded form, depending e.g. on the amount of the vacant part of the wireless communication resources. By repeating the transmission within the time period, the risk of having to retransmit the data in a later time period is lowered. In the end this means a statistically faster delivery of data to/from child IAB nodes.

According to an alternative of this embodiment, the at least a fraction of the second data is triggered for transmission at the at least two occasions using a same HARQ process.

According to another alternative, the at least a fraction of the second data is triggered for transmission at a first occasion of the at least two occasions using a first HARQ process and at a second occasion of the at least two occasions using a second HARQ process. In a variant, when the first RAN node 110 receives an acknowledgement message from the second RAN node 120 for the first HARQ process and the second HARQ process has not been completed, the second HARQ process is flushed. Hereby, communication resources needed for the second HARQ process is saved and may be used for other purposes.

According to another embodiment, the information of a vacant part of the wireless communication resources at the time period is obtained 206 in a control message received from another network node of the IAB wireless communication network. The other network node may be a node in the core network or any other RAN node, such as the donor RAN node 103.

According to another embodiment, the information of a vacant part of the wireless communication resources at the time period is obtained 206 from a determination of communication performance over the connection between the first RAN node 110 and the core network 150. In case the first RAN node is connected to the core network via a wireless connection to a donor RAN node 130 it would be communication performance over the wireless connection to the donor RAN that is determined. The communication performance may be determined from buffer build-up, amount of data delivered/throughput measurement or determined from size and frequency of scheduling grants or scheduled data.

According to another embodiment, the first data transmission has a higher likelihood of experiencing a decoding failure than the second data transmission. Further, the method comprises selecting 207 the first data for transmission in a more robust way ahead of selecting the second data for transmission in a more robust way. Then the triggering 210 of transmission of the first data and the second data comprises triggering transmission using the first part of the wireless communication resources and the at least a fraction of the vacant part of the wireless communication resources for the first data, and using the second part of the wireless communication resources for the second data.

According to another embodiment, the first data is in a second or subsequent attempt in a transmission procedure and the second data is in a first attempt in a transmission procedure. The method further comprises selecting 207 the first data for transmission in a more robust way ahead of selecting the second data for transmission in a more robust way. Further, the triggering 210 of transmission of the first data and the second data comprises triggering transmission using the first part of the wireless communication resources and the at least a fraction of the vacant part of the wireless communication resources for the first data, and using the second part of the wireless communication resources for the second data.

According to yet another embodiment, the second data is related to a second UE 122 connected to the second RAN node 120. Further, the first UE 121 has a higher priority than the second UE 122, or the first UE 121 is situated further away from the second RAN node 120 than the second UE 122, or the first UE is moving with a higher speed than the second UE. The method further comprises selecting 207 the first data for transmission in a more robust way ahead of selecting the second data for transmission in a more robust way. Further, the triggering 210 of transmission of the first data and the second data comprises triggering transmission using the first part of the wireless communication resources and the at least a fraction of the vacant part of the wireless communication resources for the first data, and using the second part of the wireless communication resources for the second data.

In IAB networks, as the number of wireless communication hops towards child IAB nodes increases, the end-to-end data transmission delay for the UEs of the last child IAB may increase significantly. On the other hand, it can be noticed that the last hops remain off in some periods, i.e. the backhaul wireless communication resources are not used or at least not all of the resources are used, until the data transmission in the initial hops finishes. In other words, there must be data available at an IAB RAN node before the data can be forwarded. This is one motivation for embodiments of the invention in which such idle backhaul communication resources of an IAB node is used to reduce IAB network end-to-end transmission delay as well as error probability. It is proposed that an IAB node that experiences vacant backhaul wireless communication resources, e.g. due to limited backhaul throughput, modify its radio resource management (RRM), in other words allocation, in such a way that unused time and/or frequency radio resources are used in a data transmission that trade the extra time/frequency consumption with increased redundancy and robustness for the transmission.

According to an embodiment, for the IAB nodes to be able to transmit/receive wireless signals to/from the upstream IAB node or IAB donor node, i.e., to/from the parent nodes, they are equipped with a mobile termination unit, which is a kind of UE function adapted to be a part of an IAB node in order to make it possible for the IAB node to receive/transmit wireless signals from other IAB nodes according to standards such as LTE and NR, as the LTE and NR standards assume to have wireless communication between a RAN node (gNB, eNB) and UE, but not between a RAN node (gNB, eNB) and a RAN node (gNB, eNB).

It is assumed that the IAB node performing RRM obtains an explicit or implicit indication of vacant backhaul communication resources. The explicit indication may include a control message from e.g. a parent IAB node to a child IAB node, from another RAN node, or from a network function informing of vacant resources. The implicit indication may include uplink buffer status information, information of a reduced amount of data delivered in downlink (may be instantaneous or measured over multiple slots), a throughput measurement performed between the child IAB node towards its IAB parent. The implicit indication may also be inferred from the size and/or frequency of occurrence of scheduling grants.

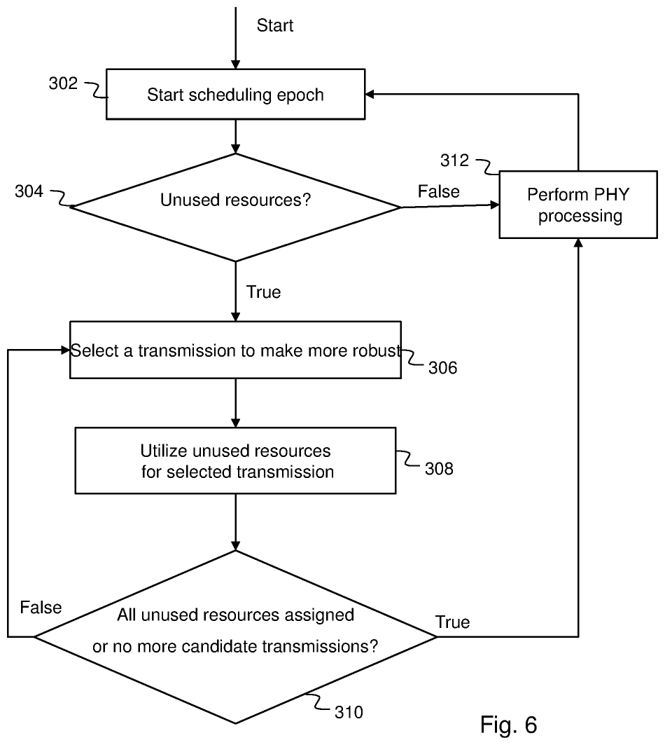

FIG. 6 shows an embodiment of a method for using unused resources for achieving more robust transmission over a backhaul wireless communication link in an IAB network. The method is described in downlink direction but might as well be used in uplink direction.

At the beginning of a scheduling epoch 302, i.e. when an IAB node schedules transmission of data directed to different UEs of child IAB nodes or to any of the child IAB nodes over the wireless backhaul link, the IAB node in question should distribute data from its buffers, performing assignments according to a scheduling policy, for example, according to a proportional fair policy. For the uplink direction, the IAB node in question would distribute uplink scheduling grants in a similar way, according to a scheduling policy such as round robin, this typically means assigning uplink resources to child IAB nodes or UEs that have data to transmit.

If an indication is obtained 304 that there will be unused backhaul communication resources for that epoch, the scheduler selects 306 at least one of the originally scheduled transmissions to make more robust. Thereafter, parts of the unused resources are utilized 308 for the selected transmission, by re-assigning, using the already assigned resources and the parts of the unused resources. In other words, more communication resources are used for the same transmission, and thereby the transmission can be made more robust. The term “transmission” is used to refer to for example an LTE transport block, an NR transport block, an NR control block group (CBG), a MAC Packet Data Unit (PDU), an RLC PDU or an NR MAC Control Element (CE). If there is no indication of unused backhaul communication resources in step 304, PHY processing 312 is performed according to the originally scheduled transmissions and a new epoch is scheduled 302. Further, following step 308, it is checked 310 whether all unused resources are assigned or if there are no more transmissions that are candidates for a more robust transmission. If so, PHY processing 312 is performed according to the re-assignment and then a new epoch is scheduled and the process of FIG. 3 is repeated for that epoch. However, if not all unused resources have been assigned and if there are spare candidate transmissions 310, a new transmission is selected 306 and unused resources are utilized for that transmission.

According to an embodiment, the above method may also comprise a step of calculating the amount of unused backhaul resources. In that case all, or at least main part of transmissions to make more robust can be selected at the step 306 and the unused resources will be utilized in step 308 and the method will then proceed to step 312.

According to an embodiment, the selected transmission(s) are made more robust by selecting a more robust transport format for at least a fraction of the transmission, taking advantage of the found unused communication resources. One way to perform the modification is to re-encode the original transmission with a more robust transport format, i.e. which introduces more redundancy, or reduces the modulation size. This can be achieved by lowering the MCS for the transmission.

According to another embodiment, the selected transmission(s) are made more robust by duplicating the selected transmission. According to an embodiment, duplication means repeating at least part of the original transmission, in an encoded or un-encoded form within the same scheduling epoch. According to another embodiment, the duplication may be sent in the same HARQ process or in different HARQ processes. The alternative with different HARQ processes is described in a separate method further down. It is assumed that the resulting selected transmission(s) fit in the selected amount of unused resources.

There may be different criteria for selecting 306 transmissions to make more robust. The criteria include, but are not limited to:
i. Transmissions with high likelihood of decoding failure, e.g. which have low redundancy.
ii. Transmissions that are in the second or subsequent attempts in a HARQ and/or possibly an ARQ procedure.
iii. Transmissions that target or are sent to/from a prioritized UE or a UE of a certain UE class or UE-equivalent, such as a mobile termination unit of an IAB node.
iv. Transmissions that target or are sent to/from network nodes or UEs at the cell border or UEs moving at considerable speeds.

In the following, an embodiment is described in which a more robust transmission of data is achieved by using originally scheduled and found vacant transmission resources for duplicating transmissions. In the following, the data to be transmitted is exemplified by MAC data units. With the term MAC data units, it is referred to both RLC PDUs, which are input to the MAC layer in 3GPP, but also MAC Control Elements (MAC CE). Further, in this embodiment, two HARQ processes are used to distribute the duplicated MAC data units. It should be clear to one skilled in the art that other choices of the number of involved HARQ processes and duplicate sets are possible.

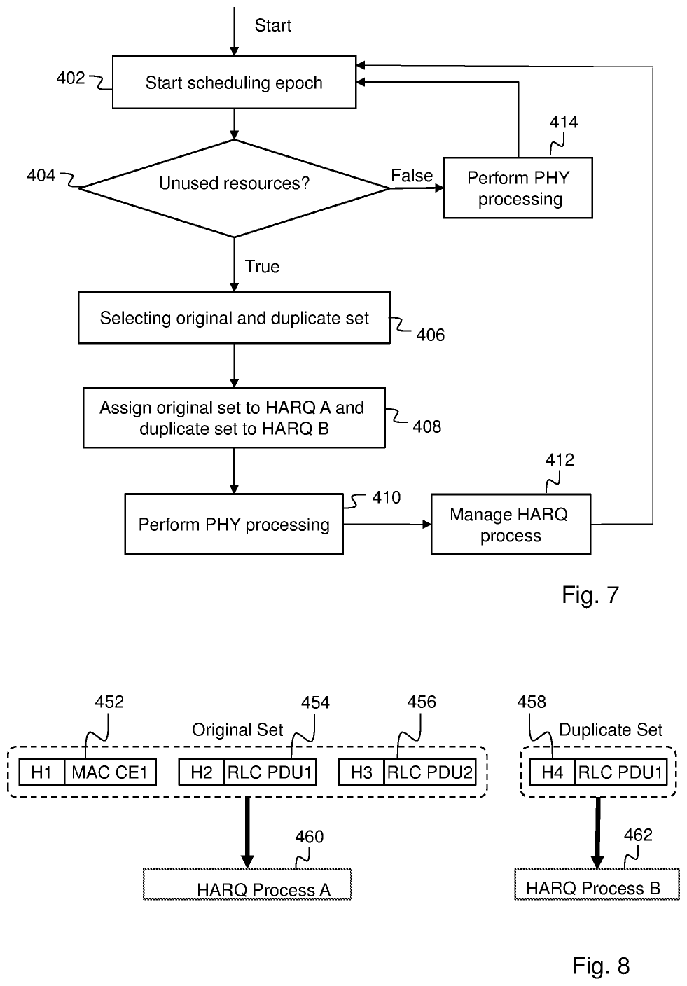

A method of this embodiment is described with reference to FIG. 7. The method starts at the beginning of a scheduling epoch 402, wherein the IAB node schedules transmission of MAC data units directed to different UEs served by child IAB nodes or to any of the child IAB nodes over the wireless backhaul link according to a scheduling policy. If an indication is obtained 404 that there will be unused backhaul communication resources for that epoch after scheduling, the entity performing MAC layer processing at the IAB node selects 406 a subset of the available MAC data units for more robust transmission. We denote this subset of data units as the “original set”. Then at least a subset of the MAC data units in the “original set” are selected for duplication. We denote this subset of the original set, the “duplicate set”. Thereafter, and possibly during PHY processing, a first transport block is formed, comprising the MAC data units in the original set. The first transport block is assigned 408 to a first HARQ process, denoted HARQ A. Further, a second transport block is formed comprising the MAC data units in the duplicate set. This second transport block is assigned 408 to a second HARQ process, independent from the first HARQ process, denoted HARQ B. From this point and onwards, the PHY layer processing 410 continues following standardized procedures. Both HARQ process A and B execute their transmissions. If there are no indication obtained 404 of unused backhaul communication resources, PHY processing 414 is performed according to the originally scheduled transmissions and a new epoch is scheduled 402.

FIG. 8 shows an example of MAC data unit duplication. The original set here contains a first data unit 452 including MAC CE1, a second data unit 454 including RLC PDU1 and a third data unit 456 including RLC PDU2. As seen, in this example the duplicate set only contains one data unit 458 including the RLC PDU1. H1, H2, H3 and H4 stands for the header of each respective data unit. Then a transport block formed from the original set is assigned to a first HARQ process 460, whereas a transport block formed from the duplicate set is assigned a second HARQ process 462.

Going back to FIG. 7, as soon as one of the HARQ processes receives an acknowledgment from e.g. the child IAB node, the IAB node is responsible for managing 412 the other HARQ process. If the first HARQ process receives an ACK, the second process is flushed, as long as the data unit or data units of the second process are completely contained in the data units of the first process. In the example of FIG. 7, if the first HARQ process receives an ACK, the second HARQ process is flushed as RLC PDU1 is contained in the original set. Had it been the opposite way in the example of FIG. 7, if the second HARQ process receives a NACK but the second an ACK, the first HARQ process cannot be flushed as it contains other data units than the RLC PDU1. The flushing operation can be realized by assigning a new transport block to the HARQ process that is to be flushed. When that HARQ process transmits, the transmissions should be flagged as carrying new data, for example, by setting the new data indicator on NR Downlink control Information (DCI). This allows a receiving unit or node, such as a receiving IAB node or a mobile termination unit of the IAB node, to flush the soft buffer for that HARQ process. If both HARQ process A and HARQ process B succeed and duplicate RLC PDUs are delivered, these will be discarded by upper layers, according to standardized procedures for LTE and NR.

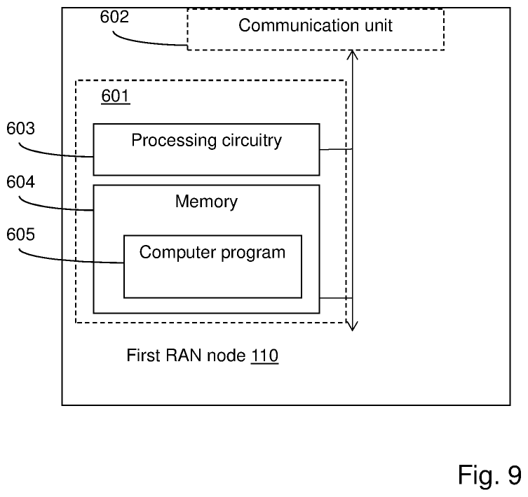

FIG. 9, in conjunction with FIG. 1, 3 or 4, illustrates a first RAN node 110 operable in an IAB wireless communication network 100. The first RAN node 110 is arranged for being connected to a core network 150 and for wireless communication with a second RAN node 120 and with a number of UEs 111, 112. The first RAN node is further allocated wireless communication resources for communication with the second RAN node 120. The first RAN node 110 comprises a processing circuitry 603 and a memory 604. Said memory contains instructions executable by said processing circuitry, whereby the first RAN node 110 is operative for assigning a first part of the wireless communication resources for transmission of first data between the first RAN node 110 and the second RAN node 120 at a time period, the first data being related to a first UE 121 connected to the second RAN node, and for assigning a second part of the wireless communication resources for transmission of second data between the first RAN node 110 and the second RAN node 120 at the time period. The first RAN node 110 is further operative for obtaining information of a vacant part of the wireless communication resources at the time period, and for triggering transmission of the first data and the second data between the first RAN node 110 and the second RAN node 120 at the time period using the first part of the wireless communication resources for the first data, the second part of the wireless communication resources for the second data and at least a fraction of the vacant part of the wireless communication resources for at least one of the first data and the second data.

According to another embodiment, the first RAN node 110 is further operative for assigning the first part of the communication resources for the transmission of the first data, the second part for the transmission of the second data and at least a fraction of the vacant part for the transmission of at least one of the first data and the second data. Further, the first RAN node is operative for performing the triggering of transmission according to the assigning of the first part, the second part and the at least fraction of the vacant part.

According to another embodiment, the first RAN node 110 is connected to the core network 150 via a wireless connection to a donor RAN node 130, the donor RAN node 130 being arranged for wireless communication with a number of UEs 131, 132.

According to yet another embodiment, the information of a vacant part of the wireless communication resources at the time period comprises information of the amount of vacant resources. The first RAN node is further operative for selecting the first data and the second data for transmission in a more robust way, when the amount of vacant resources is above a level. Further, the first RAN node is operative for triggering the transmission of the first data using the first part of the wireless communication resources and a first fraction of the vacant part and triggering the transmission of the second data using the second part of the wireless communication resources and a second fraction of the vacant part.

According to yet another embodiment, the first RAN node 110 is operative for triggering of transmission of the first data and the second data by triggering transmission of the second data using the second part of the wireless communication resources and at least a fraction of the vacant part by transmitting at least a fraction of the second data in a more robust transport format than a transport format selected at the assigning of the second part of the wireless communication resources.

According to another embodiment, the first RAN node 110 is operative for triggering of transmission of the first data and the second data by triggering transmission of the second data using the second part of the wireless communication resources and at least a fraction of the vacant part by transmitting at least a fraction of the second data at at least two occasions within the time period.

According to another embodiment, the first RAN node 110 is operative for triggering transmission of the at least fraction of the second data at the at least two occasions using a same HARQ process.

According to still another embodiment, the first RAN node 110 is operative for triggering transmission of the at least fraction of the second data at a first occasion of the at least two occasions using a first HARQ process and at a second occasion of the at least two occasions using a second HARQ process.

According to yet another embodiment, the first RAN node 110 is operative for flushing the second HARQ process when receiving an acknowledgement message from the second RAN node 120 for the first HARQ process, and the second HARQ process has not been completed.

According to still another embodiment, the first RAN node 110 is operative for obtaining the information of a vacant part of the wireless communication resources at the time period in a control message received from another network node of the IAB wireless communication network.

According to another embodiment, the first RAN node 110 is operative for obtaining the information of a vacant part of the wireless communication resources at the time period from a determination of communication performance over the connection between the first RAN node 110 and the core network 150.

According to another embodiment, the first data transmission has a higher likelihood of experiencing a decoding failure than the second data transmission. Further, the first RAN node is operative for selecting the first data for transmission in a more robust way ahead of selecting the second data for transmission in a more robust way. Also, the first RAN node is operative for the triggering of transmission of the first data and the second data by triggering transmission using the first part of the wireless communication resources and the at least a fraction of the vacant part of the wireless communication resources for the first data, and using the second part of the wireless communication resources for the second data.

According to another embodiment, the first data is in a second or subsequent attempt in a transmission procedure and the second data is in a first attempt in a transmission procedure. Further, the first RAN node is operative for selecting the first data for transmission in a more robust way ahead of selecting the second data for transmission in a more robust way. Also, the first RAN node is operative for the triggering of transmission of the first data and the second data by triggering transmission using the first part of the wireless communication resources and the at least a fraction of the vacant part of the wireless communication resources for the first data, and using the second part of the wireless communication resources for the second data.

According to another embodiment, the second data is related to a second UE 122 connected to the second RAN node 120. Further, the first UE 121 has a higher priority than the second UE, or the first UE 121 is situated further away from the second RAN node 120 than the second UE 122, or the first UE is moving with a higher speed than the second UE. Further, the first RAN node is operative for selecting the first data for transmission in a more robust way ahead of selecting the second data for transmission in a more robust way. Also, the first RAN node is operative for the triggering of transmission of the first data and the second data by triggering transmission using the first part of the wireless communication resources and the at least a fraction of the vacant part of the wireless communication resources for the first data, and using the second part of the wireless communication resources for the second data.

According to other embodiments, the first RAN node 110 may further comprise a communication unit 602, which may be considered to comprise conventional means for wireless communication with other RAN nodes 120, 130 and with wireless communication devices 111, 112, such as a transceiver for wireless transmission and reception of signals. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the first RAN node 110 to perform the steps described in any of the described embodiments of the first RAN node 110 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). Further, the computer program 605 may be carried by a separate computer-readable medium, such as a CD, DVD or flash memory, from which the program could be downloaded into the memory 604. Alternatively, the computer program may be stored on a server or any other entity to which the first RAN node 110 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a first radio access network, RAN, node of an integrated access and backhaul, IAB, wireless communication network, the IAB wireless communication network further comprising a second RAN node, the first RAN node being connected to a core network, the first RAN node being arranged for wireless communication with the second RAN node and with a number of UEs, wireless communication resources being allocated for communication between the first RAN node and the second RAN node, the method comprising:
assigning a first part of the wireless communication resources for transmission of first data between the first RAN node and the second RAN node at a time period, the first data being related to a first UE connected to the second RAN node;
assigning a second part of the wireless communication resources for transmission of second data between the first RAN node and the second RAN node at the time period;
obtaining information of a vacant part of the wireless communication resources at the time period; and
triggering transmission of the first data and the second data between the first RAN node and the second RAN node at the time period using the first part of the wireless communication resources for the first data, the second part of the wireless communication resources for the second data and at least a fraction of the vacant part of the wireless communication resources for at least one of the first data and the second data.

2. The method according to claim 1, further comprising:
assigning the first part of the communication resources for the transmission of the first data, the second part for the transmission of the second data and at least a fraction of the vacant part for the transmission of at least one of the first data and the second data, wherein the triggering of transmission is performed according to the assigning of the first part, the second part and the at least fraction of the vacant part.

3. The method according to claim 1, wherein the first RAN node is connected to the core network via a wireless connection to a donor RAN node, the donor RAN node being arranged for wireless communication with a number of UEs.

4. The method according to claim 1, wherein the information of a vacant part of the wireless communication resources at the time period comprises information of the amount of vacant resources, and the method comprises:
when the amount of vacant resources is above a level, selecting the first data and the second data for transmission in a more robust way; and
wherein the triggering of transmission of the first data and the second data comprises triggering transmission of the first data using the first part of the wireless communication resources and a first fraction of the vacant part and triggering transmission of the second data using the second part of the wireless communication resources and a second fraction of the vacant part.

5. The method according to claim 1, wherein the triggering of transmission of the first data and the second data comprises triggering transmission of the second data using the second part of the wireless communication resources and at least a fraction of the vacant part by transmitting at least a fraction of the second data in a more robust transport format than a transport format selected at the assigning of the second part of the wireless communication resources.

6. The method according to claim 1, wherein the triggering of transmission of the first data and the second data comprises triggering transmission of the second data using the second part of the wireless communication resources and at least a fraction of the vacant part by transmitting at least a fraction of the second data at at least two occasions within the time period.

7. The method according to claim 6, wherein the at least a fraction of the second data is triggered for transmission at the at least two occasions using a same HARQ process.

8. The method according to claim 6, wherein the at least a fraction of the second data is triggered for transmission at a first occasion of the at least two occasions using a first HARQ process and at a second occasion of the at least two occasions using a second HARQ process.

9. The method according to claim 8, wherein when the first RAN node receives an acknowledgement message from the second RAN node for the first HARQ process and the second HARQ process has not been completed, flushing the second HARQ process.

10. The method according to claim 1, wherein the information of a vacant part of the wireless communication resources at the time period is obtained in a control message received from another network node of the IAB wireless communication network.

11. The method according to claim 1, wherein the information of a vacant part of the wireless communication resources at the time period is obtained from a determination of communication performance over the connection between the first RAN node and the core network.

12. The method according to claim 1, wherein the first data transmission has a higher likelihood of experiencing a decoding failure than the second data transmission, and the method further comprises:
selecting the first data for transmission in a more robust way ahead of selecting the second data for transmission in a more robust way; and
the triggering of transmission of the first data and the second data comprises triggering transmission using the first part of the wireless communication resources and the at least a fraction of the vacant part of the wireless communication resources for the first data, and using the second part of the wireless communication resources for the second data.

13. The method according to claim 1, wherein the first data is in a second or subsequent attempt in a transmission procedure and the second data is in a first attempt in a transmission procedure, and the method further comprises:
selecting the first data for transmission in a more robust way ahead of selecting the second data for transmission in a more robust way; and
the triggering of transmission of the first data and the second data comprises triggering transmission using the first part of the wireless communication resources and the at least a fraction of the vacant part of the wireless communication resources for the first data, and using the second part of the wireless communication resources for the second data.

14. The method according to claim 1, wherein the second data is related to a second UE connected to the second RAN node, wherein one of the first UE has a higher priority than the second UE, the first UE is situated further away from the second RAN node than the second UE and the first UE is moving with a higher speed than the second UE, and the method further comprises:
selecting the first data for transmission in a more robust way ahead of selecting the second data for transmission in a more robust way; and
the triggering of transmission of the first data and the second data comprises triggering transmission using the first part of the wireless communication resources and the at least a fraction of the vacant part of the wireless communication resources for the first data, and using the second part of the wireless communication resources for the second data.

15. A first RAN node operable in an IAB wireless communication network and arranged for being connected to a core network and for being arranged for wireless communication with a second RAN node and with a number of UEs, and for being allocated wireless communication resources for communication with the second RAN node, the first RAN node comprising a processing circuitry and a memory, said memory containing instructions executable by said processing circuitry, the first RAN node being configured for:
assigning a first part of the wireless communication resources for transmission of first data between the first RAN node and the second RAN node at a time period, the first data being related to a first UE connected to the second RAN node;
assigning a second part of the wireless communication resources for transmission of second data between the first RAN node and the second RAN node at the time period;
obtaining information of a vacant part of the wireless communication resources at the time period; and
triggering transmission of the first data and the second data between the first RAN node and the second RAN node at the time period using the first part of the wireless communication resources for the first data, the second part of the wireless communication resources for the second data and at least a fraction of the vacant part of the wireless communication resources for at least one of the first data and the second data.

16. The first RAN node according to claim 15, further configured for:
assigning the first part of the communication resources for the transmission of the first data, the second part for the transmission of the second data and at least a fraction of the vacant part for the transmission of at least one of the first data and the second data, wherein the first RAN node is configured for performing the triggering of transmission according to the assigning of the first part, the second part and the at least fraction of the vacant part.

17. The first RAN node according to claim 15, wherein the first RAN node is connected to the core network via a wireless connection to a donor RAN node, the donor RAN node being arranged for wireless communication with a number of UEs.

18. The first RAN node according to claim 15, wherein the information of a vacant part of the wireless communication resources at the time period comprises information of the amount of vacant resources, and the first RAN node is further configured for:
when the amount of vacant resources is above a level, selecting the first data and the second data for transmission in a more robust way; and
the first RAN node is configured for triggering the transmission of the first data using the first part of the wireless communication resources and a first fraction of the vacant part and triggering the transmission of the second data using the second part of the wireless communication resources and a second fraction of the vacant part.

19. The first RAN node according to claim 15, configured for triggering of transmission of the first data and the second data by triggering transmission of the second data using the second part of the wireless communication resources and at least a fraction of the vacant part by transmitting at least a fraction of the second data in a more robust transport format than a transport format selected at the assigning of the second part of the wireless communication resources.

20. The first RAN node according to claim 15, configured for triggering of transmission of the first data and the second data by triggering transmission of the second data using the second part of the wireless communication resources and at least a fraction of the vacant part by transmitting at least a fraction of the second data at at least two occasions within the time period.

21. The first RAN node according to claim 20, configured for triggering transmission of the at least a fraction of the second data at the at least two occasions using a same HARQ process.

22. The first RAN node according to claim 20, configured for triggering transmission of the at least a fraction of the second data at a first occasion of the at least two occasions using a first HARQ process and at a second occasion of the at least two occasions using a second HARQ process.

23. The first RAN node according to claim 22, configured for flushing the second HARQ process when receiving an acknowledgement message from the second RAN node for the first HARQ process and the second HARQ process has not been completed.

24.-28. (canceled)

29. A computer storage medium storing a computer program comprising instructions, which, when executed by at least one processing circuitry of a first RAN node of an IAB wireless communication network, causes the first RAN node to perform a method, the method comprising:
assigning a first part of wireless communication resources allocated for communication with a second RAN node, for transmission of first data between the first RAN node and the second RAN node at a time period, the first data being related to a first UE connected to the second RAN node;
assigning a second part of the wireless communication resources for transmission of second data between the first RAN node and the second RAN node at the time period;
obtaining information of a vacant part of the wireless communication resources at the time period; and
triggering transmission of the first data and the second data between the first RAN node and the second RAN node at the time period using the first part of the wireless communication resources for the first data, the second part of the wireless communication resources for the second data and at least a fraction of the vacant part of the wireless communication resources for at least one of the first data and the second data

30. (canceled)
